(19) United States
(12) Patent Application Publication
(10) Pub. No.: US 2025/0069038 A1
(43) Pub. Date: Feb. 27, 2025

(54) METHOD AND SYSTEM FOR RECOMMENDING REPORT MATERIAL

(71) Applicant: Wistron Corporation, New Taipei City (TW)

(72) Inventors: Chun-Hsien Li, New Taipei City (TW); Chia-Chiung Liu, New Taipei City (TW); Manshiuan Shiu, New Taipei City (TW)

(73) Assignee: Wistron Corporation, New Taipei City (TW)

(21) Appl. No.: 18/471,317

(22) Filed: Sep. 21, 2023

(30) Foreign Application Priority Data
Aug. 21, 2023 (TW) 112131386

(51) Int. Cl. G06Q 10/105

(52) U.S. Cl. CPC G06Q 10/105

(57) ABSTRACT

The disclosure provides a method and a system for recommending report material. The method includes the following steps. A plurality of evaluated reports and an actual rating level of each of the evaluated reports are obtained. A plurality of reference text materials related to a rating topic are extracted from the evaluated reports. A classification model training is performing based on the reference text materials and the actual rating levels of the evaluated reports to establish a text level classification model. Predicted level information for each of text materials to be evaluated is determined by using the text level classification model, to obtain recommended order for each of the text materials to be evaluated. A report is generated based on the recommended order of each of the text materials to be evaluated.

### BACKGROUND

### Technical Field

The disclosure relates to an automatic report compiling method, and particularly relates to a method and a system for recommending report material.

### Description of Related Art

In recent years, energy conservation and carbon reduction have become a hot topic that many enterprises pay attention to, and many enterprises have made great efforts for corporate social responsibility (CSR) reports. The CSR report is a relevant document used by an enterprise or organization to present its sustainable development, and its content may include information on performance of the enterprise in terms of economy, society, and environment. The CSR report may cover multiple sustainability topics to present sustainable development information of the enterprise. Rating of the CSR report is mainly carried out by external agencies, investors, professional organizations or independent evaluation agencies. The above-mentioned evaluation agencies may include government agencies, non-governmental organizations, or environmental protection groups, etc. These evaluation agencies usually evaluate, check and rank the CSR reports of the enterprises to determine their performance in terms of sustainable development. If the CSR report of any enterprise may obtain a higher rating score, it may help the overall operation and sustainable image of the enterprise to increase benefit.

However, it is difficult for each enterprise to clearly understand how to collect data and how to write a CSR report. Generally, regarding a same sustainability topic, the enterprises may have different implementation plans and implementation results. At present, most of the CSR reports are written and revised based on experiences of expert consultants, and the content of the report meets environmental, social and governance (ESG) requirements and is recognized by various enterprises. However, unexpected situations and errors may occur in the writing and revision of the CSR report base on human experiences, and thus it is unable to achieve a high-quality CSR report. Therefore, how to compile the information of these implementation plans and implementation results into the CSR report to produce a qualified CSR report with a high rating score is an important challenge that every enterprise pays attention to.

### SUMMARY

The disclosure is directed to a method for recommending report material and a report material recommending system, which are adapted to solve the above mentioned technical problems.

An embodiment of the disclosure provides a method for recommending report material, which is adapted to a report material recommending system including a processing device, and includes following steps. A plurality of evaluated reports and an actual rating level of each of the evaluated reports are obtained. A plurality of reference text materials related to a rating topic are extracted from the evaluated reports. A classification model training is performing based on the reference text materials and the actual rating levels of the evaluated reports to establish a text level classification model. Predicted level information for each of text materials to be evaluated is determined by using the text level classification model, to obtain a recommended order for each of the text materials to be evaluated. A report is generated based on the recommended order of each of the text materials to be evaluated.

An embodiment of the disclosure provides a report material recommending system including a storage device and a processing device. The storage device stores a plurality of instructions. The processing device is coupled to the storage device, and accesses the instructions and is configured to perform the following operations. A plurality of evaluated reports and an actual rating level of each of the evaluated reports are obtained. A plurality of reference text materials related to a rating topic are extracted from the evaluated reports. A classification model training is performing based on the reference text materials and the actual rating levels of the evaluated reports to establish a text level classification model. Predicted level information for each of text materials to be evaluated is determined by using the text level classification model, so as to obtain a recommended order for each of the text materials to be evaluated. A report is generated based on the recommended order of each of the text materials to be evaluated.

Based on the above description, in the embodiments of the disclosure, a plurality of reference text materials related to the rating topic may be generated according to a plurality of past evaluated reports, and then model training is performed according to the reference text materials and the corresponding actual rating levels to establish the text level classification model. The text level classification model learns rating criteria of a rating agency that produces the actual rating levels. Therefore, the text level classification model may be used to generate the respective predicted level information of the plurality of text materials to be evaluated, so that the recommended order of each of the text materials to be evaluated may be generated according to the respective predicted level information. An appropriate target text material may be determined according to the recommended order of each text material to be evaluated, and the report may be generated according to the appropriate target text material. In this way, the overall quality of the report is increased and the writing efficiency is improved.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a report material recommending system according to an embodiment of the disclosure.

FIG. 2 is a flowchart of a method for recommending report material according to an embodiment of the disclosure.

FIG. 3 is a flowchart of acquiring a plurality of reference text materials according to an embodiment of the disclosure.

FIG. 4A is a schematic diagram of training a text level classification model according to an embodiment of the disclosure.

FIG. 4B is a schematic diagram of applying the text level classification model according to an embodiment of the disclosure.

FIG. 5A is a flowchart of obtaining recommended orders of a plurality of text materials to be evaluated according to an embodiment of the disclosure.

FIG. 5B is a flowchart of obtaining recommended orders of a plurality of text materials to be evaluated according to an embodiment of the disclosure.

FIG. 6 is a flowchart of generating a report according to an embodiment of the disclosure.

### DESCRIPTION OF THE EMBODIMENTS

Some embodiments of the disclosure will be described in detail with reference to the accompanying drawings. For the referenced component symbols in the following description, when the same component symbols appear in different drawings, they will be regarded as the same or similar components. These embodiments are only a part of the disclosure, and do not reveal all possible implementations of the disclosure. Rather, these embodiments are merely examples of devices and methods within a scope of the claims of the disclosure.

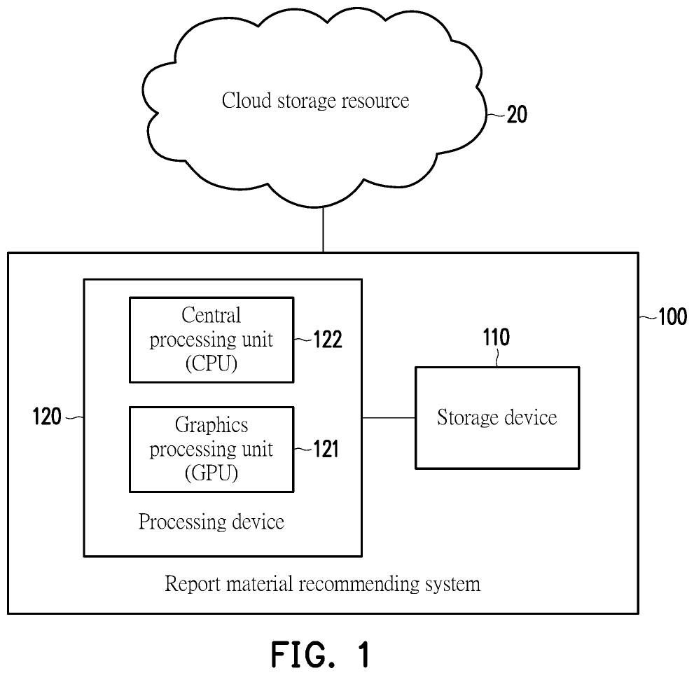

Referring to FIG. 1, FIG. 1 is a schematic diagram of a report material recommending system according to an embodiment of the disclosure. In different embodiments, a report material recommending system 100 may be implemented by a computing device such as a computer, a server, a workstation, etc., but the disclosure is not limited thereto. In some embodiments, the report material recommending system 100 may be a server device, a server cluster composed of multiple server devices, or other distributed systems, which is not limited by the disclosure. The report material recommending system 100 may include a storage device 110 and a processing device 120.

The storage device 110 is, for example, any type of fixed or removable random access memory (RAM), read-only memory (ROM), flash memory, solid-state drive, hard drive, or other similar devices, or a combination of these devices, that may be used to record a plurality of instructions, codes, or software modules.

The processing device 120 is, for example, a central processing unit (CPU), an application processor (AP), or other programmable general purpose or special purpose microprocessor, digital signal processor (DSP), graphics processing unit (GPU), application specific integrated circuit (ASIC), field programmable gate array (FPGA), or other similar devices, integrated circuits and combinations thereof. The processing device 120 may access and execute the software modules recorded in the storage device 110 to implement the method for recommending report material in the embodiment of the disclosure. The aforementioned software modules may be broadly interpreted as meaning instructions, instruction sets, codes, program codes, programs, applications, software packages, threads, procedures, functions, etc.

In some embodiments, the report material recommending system 100 may be connected to a cloud storage resource 20 via a network, so as to obtain a plurality of evaluated reports from the cloud storage resource 20. These evaluated reports are, for example, historical corporate social responsibility (CSR) reports of many enterprises in the past several years.

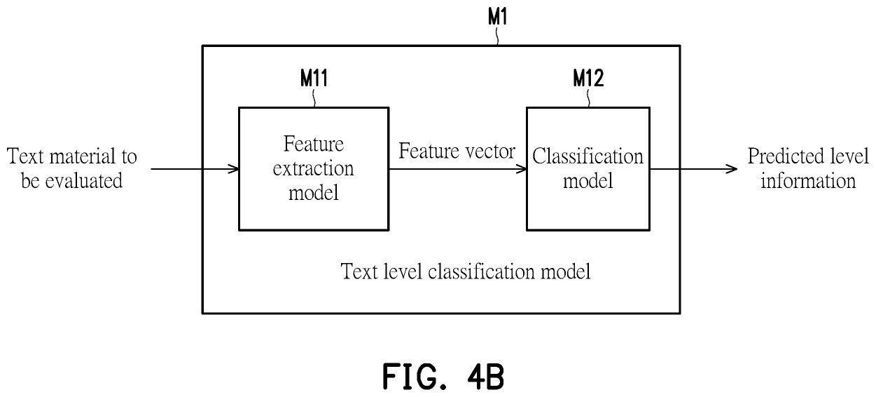

In some embodiments, the processing device 120 may include a graphics processing unit (GPU) 121 and a central processing unit (CPU) 122. The GPU 121 and the CPU 122 are respectively responsible for different calculation tasks. In some embodiments, the GPU 121 is responsible for training and execution of a first type machine learning model, and the CPU 122 is responsible for training and execution of a second type machine learning model. The above-mentioned first type machine learning model is, for example, a generative language model (such as a feature extraction model M11 in FIG. 4A), while the second type machine learning model is, for example, a classification model (such as a classification model M12 in FIG. 4A).

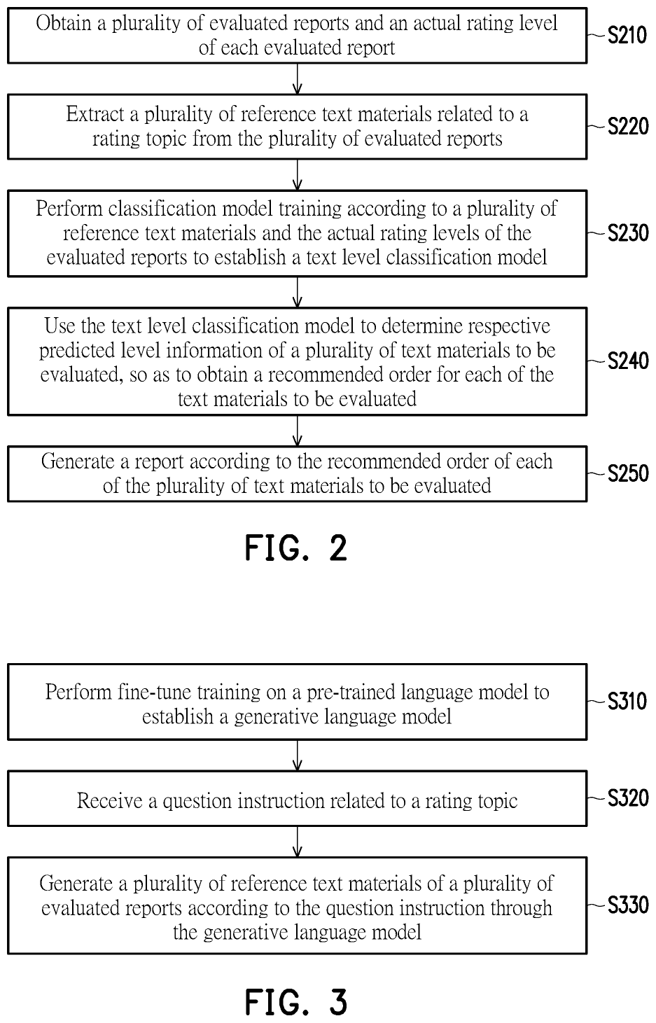

FIG. 2 is a flowchart of a method for recommending report material according to an embodiment of the disclosure. Referring to FIG. 1 and FIG. 2, the method of the embodiment is adapted to the report material recommending system 100 in the above-mentioned embodiment. Detailed steps of the method for recommending report material of the embodiment will be described below with reference of various components in the report material recommending system 100.

In step S210, the processing device 120 obtains a plurality of evaluated reports and an actual rating level of each evaluated report. In some embodiments, when the report material recommending system 100 is used to generate a CSR report of a certain enterprise for a current year, these evaluated reports may be historical CSR reports of a plurality of enterprises in the past several years. The historical CSR reports of each enterprise have been rated by one or more rating agencies and have corresponding actual rating levels. The aforementioned rating agencies are, for example, MSCI, FTSE Russell, Sustainalytics, etc. When evaluating the CSR reports, these rating agencies usually conduct ratings on the concepts of environment, society, and governance (ESG) concepts to determine performances of the enterprises in these aspects. These rating agencies may classify these historical CSR reports into one of a plurality of rating levels. These rating levels are, for example, “leading”, “average” and “lagging”. Alternatively, these ratings levels are, for example, “AAA”, “AA”, “A”, “BBB”, “BB”, “B” and “CCC”.

Specifically, the CSR reports of various enterprises are generally written based on evaluation criteria provided by various rating agencies. For example, regarding the concept of ESG, the MSCI rates the CSR report of each company with 37 rating topics in 10 major directions. Regarding the concept of environment (E), the MSCI may perform rating in 4 major directions, which are respectively “climate change”, “natural resource”, “pollution and waste” and “environmental opportunity”. Regarding the concept of society(S), the MSCI may perform rating in 4 major directions, which are respectively “human resource”, “product responsibility”, “veto power of stakeholders” and “social opportunity”. Regarding the concept of corporate governance (G), the MSCI may perform rating in two major directions, which are respectively “corporate governance” and “corporate behaviour”. Where, the MSCI may also perform rating on a plurality of rating topics in various directions. For example, “climate change” includes 4 rating topics, which are respectively “carbon emission”, “product carbon footprint”, “responsibility to climate change” and “environmental impacts of financing”.

In step S220, the processing device 120 extracts a plurality of reference text materials related to a rating topic from the plurality of evaluated reports. The reference text material is a piece of text related to the rating topic. For example, the processing device 120 may extract a plurality of reference text materials related to “carbon emission” from each of the evaluated reports. Moreover, each reference text material may be associated with an actual rating level of the corresponding evaluated report. In some embodiments, the processing device 120 may use a generative language model to extract a plurality of reference text materials related to the rating topic from a plurality of evaluated reports according to the rating topic. In some embodiments, the generative language model is, for example, generative pre-trained transformers (GPT), bidirectional encoder representations from transformers (BERT), ERNIE, PaLM2. For example, table 1 is an example of a plurality of reference text materials.

TABLE 1

| Year | Criterion | Company | Reference text material | Rating |
|---|---|---|---|---|
| 2022 | Carbon | Company | Implement a change in a | AAA |
| | emission | A | maintenance cycle of air | |
| | | | compressor equipment this | |
| | | | year to reduce carbon | |
| | | | emissions by 5% | |
| 2022 | Carbon | Company | Introduce an air | AA |
| | emission | B | conditioning group control | |
| | | | system this year, reducing | |
| | | | overall electricity consumption | |
| | | | by 2% annually | |
| . . . | . . . | . . . | . . . | . . . |
| 2020 | Product | Company | Based on intelligent | A |
| | carbon | A | production scheduling, the | |
| | footprint | | overall product reduces | |
| | | | carbon emissions by an | |
| | | | average of 2% | |

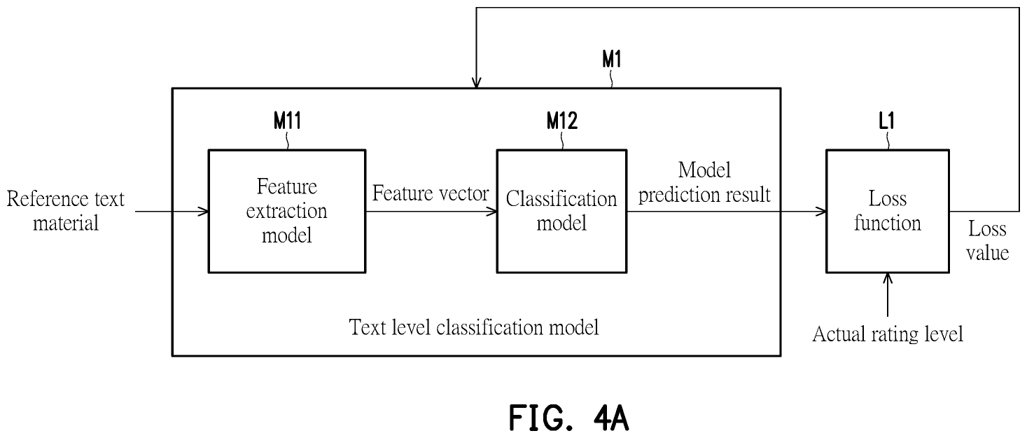

FIG. 3 is a flowchart of acquiring a plurality of reference text materials according to an embodiment of the disclosure. In some embodiments, step S220 may be implemented as steps S310 to S330. Referring to FIG. 3.

In step S310, the processing device 120 performs fine-tune training on a pre-trained language model to establish a generative language model. The generative language model is, for example, a GPT model, but the disclosure is not limited thereto. In some embodiments, a task of the generative language model includes extracting a plurality of reference textual materials related to the rating topic from the evaluated reports.

In detail, the processing device 120 may select one of the existing pre-trained language models as a basic model for performing the fine-tune training. The pre-trained language model is an artificial intelligence model pre-trained on a large-scale text dataset, and its goal is to learn to understand and generate natural language through self-supervised learning. Model fine-tune training is to use labeled training data to perform further supervised learning model training on the pre-trained language models to generate generative language models adapted to specific tasks or domains. In some embodiments, the processing device 120 may collect a plurality of evaluated reports from the cloud storage resource 20 to generate the labeled training data according to the evaluated reports, where the labeled training data includes an input text and a labeled text paired with each other. For example, the model input text in the labeled training data includes the evaluated report, and the labeled text in the labeled training data includes an abstract of the evaluated report. Afterwards, the processing device 120 may perform fine-tune training on the pre-trained language model according to the labeled training data, so as to establish the generative language model.

In step S320, the processing device 120 receives a question instruction related to a rating topic. Then, in step S330, the processing device 120 generates a plurality of reference text materials of a plurality of evaluated reports according to the question instruction through the generative language model. In detail, when applying the generative language model, the processing device 120 may input the plurality of evaluated reports and the question instruction related the rating topic into the generative language model, and the generative language model may correspondingly output abstract texts or extracted texts related to the rating topic in the plurality of evaluated reports. The above question instruction is, for example, “please extract and simplify the abstract content disclosing “carbon emission” from the CSR reports”. Correspondingly, the generative language model may output abstracts texts related to the rating topic “carbon emission” in the CSR reports of different years, so as to obtain the reference text materials related to the rating topic “carbon emission”.

Referring back to FIG. 2, in step S230, the processing device 120 performs classification model training according to a plurality of reference text materials and the actual rating levels of the evaluated reports to establish a text level classification model. The text level classification model may be trained according to a supervised machine learning algorithm to learn a correlation between these reference text materials and the corresponding actual rating levels. In other words, the text level classification model may predict a corresponding predicted level information according to the input text material.

In some embodiments, the text level classification model may include a feature extraction model and a classification model. Referring to FIG. 4A, FIG. 4A is a schematic diagram of training a text level classification model according to an embodiment of the disclosure. A text level classification model M1 may include a feature extraction model M11 and a classification model M12. During a training phase of the text level classification model M1, the processing device 120 may use the feature extraction model M11 to correspondingly convert each reference text material into a feature vector. Namely, the input of the feature extraction model M11 is the reference text material, and the output of the feature extraction model M11 is the feature vector of the reference text material. The feature extraction model M11 is, for example, an embeddings from language model (ELMO model) or a BERT model.

Next, the processing device 120 may input the feature vector of each reference text material into the classification model M12 to generate a model prediction result. The above-mentioned model prediction result may include a classification level of each reference text material or a level comparison result of multiple reference text materials. The classification model M12 is, for example, a support vector machine model (SVM model) or other machine learning models adapted to perform classification tasks.

Then, the processing device 120 may adjust a model parameter of the classification model according to the actual rating level of each evaluated report and the corresponding model prediction result. In detail, the processing device 120 may compare a difference between the model prediction result and the actual rating level to generate a loss value, and update the model parameters of the feature extraction model M11 and the classification model M12 according to a direction of minimizing the loss value. For example, the processing device 120 may input the model prediction result and the actual rating level into a loss function L1 to generate the loss value. In addition, the processing device 120 may select a pre-trained language model as a basic model of the feature extraction model M11 to perform training.

In some embodiments, the processing device 120 may input a first reference text material and a second reference text material into the text level classification model M1, and the classification model M12 may output a classification result according to a feature vector of the first reference text material and a feature vector of the second reference text material. When the classification result output by the classification model M12 is at a first value, it means that a predicted rating level of the first reference text material is superior to a predicted rating level of the second reference text material. Conversely, when the classification result output by the classification model M12 is at a second value, it means that the predicted rating level of the first reference text material is inferior to the predicted rating level of the second reference text material. For example, table 2 is an example of a model input and a model output of the text level classification model M1.

TABLE 2

| Model | First reference text | Second reference text |
|---|---|---|
| output | material | material |
| 1 | Implement a change in a | Introduce an air conditioning |
| | maintenance cycle of air | group control system this |
| | compressor equipment | year, reducing |
| | this year to | overall electricity |
| | reduce carbon | consumption by 2% annually |
| | emissions by 5% | |
| 0 | Implement a change in a | Introduce an air conditioning |
| | maintenance cycle of air | group control system this |
| | compressor equipment this | year, reducing |
| | year to reduce carbon | overall electricity |
| | emissions by 5% | consumption by 10% annually |

Referring back to FIG. 2, in step S240, the processing device 120 uses the text level classification model to determine respective predicted level information of a plurality of text materials to be evaluated, so as to obtain a recommended order for each of the text materials to be evaluated. The text material to be evaluated is, for example, a candidate text material produced by an enterprise that has an improvement plan for the rating topic of that year. For example, regarding the rating topic “carbon emission” under “climate change”, the text materials to be evaluated may include candidate text materials generated based on improvement plans such as “air conditioning group control”, “green power transfer” and “air compressor maintenance adjustment”, etc. For example, the text material to be evaluated may be “introduce air conditioning group control this year, save xxx kWh of electricity and reduce carbon emissions by ∘∘∘ tons” or “increase a recycling rate of production wastewater by xx %”. In other words, the text material to be evaluated is a candidate text material that may be probably included in the report. The input of the text level classification model may be the text material to be evaluated, so as to output the predicted level information of the text material to be evaluated.

Referring to FIG. 4B, FIG. 4B is a schematic diagram of applying the text level classification model according to an embodiment of the disclosure. The text level classification model M1 may include the feature extraction model M11 and the classification model M12. In an application phase of the text level classification model M1, the processing device 120 uses the feature extraction model M11 to convert each text material to be evaluated into a feature vector. Then, the processing device 120 uses the classification model M12 to generate the predicted level information of the text material to be evaluated according to the feature vector of the text material to be evaluated. In this way, the processing device 120 may determine a recommended order of each text material to be evaluated according to the predicted level information of the plurality of text materials to be evaluated.

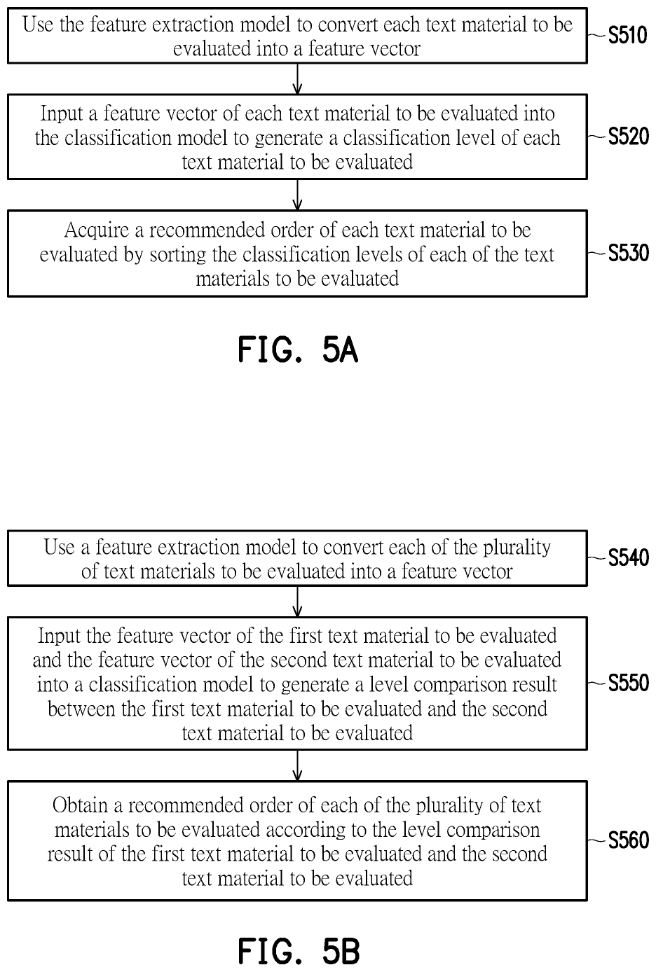

FIG. 5A is a flowchart of obtaining recommended orders of a plurality of text materials to be evaluated according to an embodiment of the disclosure. Referring to FIG. 4 and FIG. 5A, in some embodiments, step S240 may be implemented as steps S510 to S530. In step S510, the processing device 120 uses the feature extraction model M11 to convert each text material to be evaluated into a feature vector. In step S520, the processing device 120 inputs the feature vector of each text material to be evaluated into the classification model M12 to generate a classification level of each text material to be evaluated. Namely, in the embodiment, the predicted level information output by the classification model M12 is the classification level of each text material to be evaluated. For example, the processing device 120 may input the text material to be evaluated “introduce air conditioning group control this year, reduce electricity consumption by xxx kWh and reduce carbon emission by ∘∘∘ tons” into the text level classification model M1 to obtain a corresponding classification level. For example, the text level classification model M1 may classify the text material to be evaluated into one predicted rating level (i.e., the classification level) in 6 rating levels. Therefore, after obtaining the classification level of each text material to be evaluated, in step S530, the processing device 120 acquires the recommended order of each text material to be evaluated by sorting the classification levels of each of the text materials to be evaluated.

FIG. 5B is a flowchart of obtaining recommended orders of a plurality of text materials to be evaluated according to an embodiment of the disclosure. Referring to FIG. 4 and FIG. 5B, in some embodiments, step S240 may be implemented as steps S540 to S560. In step S540, the processing device 120 uses the feature extraction model M11 to convert each text material to be evaluated into a feature vector. Here, the text material to be evaluated includes a first text material to be evaluated and a second text material to be evaluated. Then, in step S550, the processing device 120 inputs the feature vector of the first text material to be evaluated and the feature vector of the second text material to be evaluated into a classification model to generate a level comparison result of the first text material to be evaluated and the second text material to be evaluated. Therefore, after obtaining the classification levels of each of the text materials to be evaluated, in step S560, the processing device 120 obtains the recommended order of each text material to be evaluated according to the level comparison result of the first text material to be evaluated and the second text material to be evaluated.

For example, the processing device 120 may combine a plurality of text materials to be evaluated related to the rating topic “carbon emission” into a plurality of material combinations. Table 3 is an example of a material combination composed of a plurality of text materials to be evaluated.

TABLE 3

| Material | First text material | Second text material |
|---|---|---|
| combination | to be evaluated | to be evaluated |
| 1 | Air conditioning group control | Green power transfer |
| 2 | Air conditioning group control | Air compressor |
| | | maintenance adjustment |
| 3 | Green power transfer | Air compressor |
| | | maintenance adjustment |

The processing device 120 may input two text materials to be evaluated in the material combinations into the text level classification model M1 to obtain a level comparison result of these material combinations. Table 4 is an example of the level comparison results of the material combinations in Table 3.

TABLE 4

| | First text | Second text | Level comparison |
|---|---|---|---|
| Material | material to be | material to be | result (model |
| combination | evaluated | evaluated | output) |
| 1 | Air | Green power | 1 |
| | conditioning | transfer | |
| | group control | | |
| 2 | Air | Air compressor | 1 |
| | conditioning | maintenance | |
| | group control | adjustment | |
| 3 | Green power | Air compressor | 0 |
| | transfer | maintenance | |
| | | adjustment | |

Where, when an output value of the text level classification model M1 is “1”, it represents that a predicted level of the first text material to be evaluated is superior to a predicted level of the second text material to be evaluated. Conversely, when the output value of the text level classification model M1 is “0”, it represents that the predicted level of the first text material to be evaluated is inferior to the predicted level of the second text material to be evaluated. Based on table 4, it may be learned that the recommended order of the text material to be evaluated “air conditioner group control” is the first; the recommended order of the text material to be evaluated “air compressor maintenance adjustment” is the second; the recommended order of the text material to be evaluated “green power transfer” is the third. The processing device 120 may also generate recommended orders of a plurality of text materials to be evaluated related to other rating topics according to the same operation method.

In step S250, the processing device 120 generates a report according to the recommended order of each of the plurality of text materials to be evaluated. In some embodiments, the processing device 120 may discard the text material to be evaluated with a lower recommended order and select the text material to be evaluated with a higher recommended order to generate the report.

It should be noted that, in some embodiments, before the text materials to be evaluated are sequentially input into the text classification model M1, the processing device 120 may replace an influence value in each text material to be evaluated with a preset value. In this way, it is possible to prevent confidential information of the enterprise from being leaked due to uploading to an external server running the text level classification model M1. Then, after selecting a target text material and accordingly generating the report, the processing device 120 may replace the preset value in the report with the original influence value. For example, the processing device 120 may input the text material to be evaluated “introduce air conditioning group control this year, reduce electricity consumption by X tens of million kWh and reduce carbon emission by Y kilotons” with the influence value removed to the text level classification model M1, to obtain its classification level. Where, X and Y are default values. Then, if the text material to be evaluated “introduce air conditioning group control this year, reduce electricity consumption by X tens of millions kWh and reduce carbon emission by Y kilotons” is selected as the target text material, the processing device 120 fills back the real influence value to generate a report including the text material “introduce air conditioning group control this year, reduce electricity consumption by 11 million kWh and reduce carbon emission by 8.4 kilotons”.

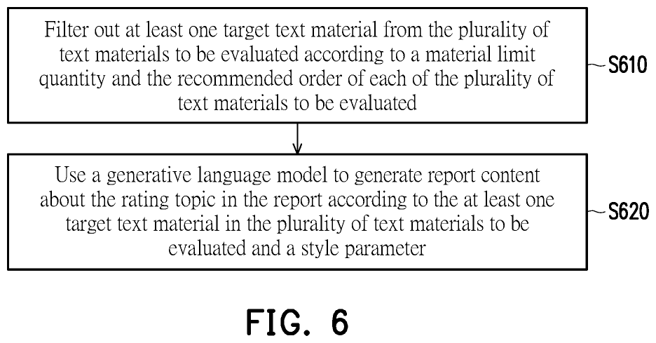

FIG. 6 is a flowchart of generating a report according to an embodiment of the disclosure Referring to FIG. 6, in some embodiments, step S250 may be implemented as steps S610 to S620.

In step S610, the processing device 120 filters out at least one target text material from the plurality of text materials to be evaluated according to a material limit quantity and the recommended orders of each of the text materials to be evaluated. In case that the report actually has a length limitation, there are also limitations on lengths of various rating topics. Based on the above, the processing device 120 may filter out at least one target text material according to the material limit quantity and the recommended order of each text material to be evaluated. It should be noted that different rating topics may have different material limit quantities. For example, the material limit quantity for the rating topic “carbon emission” may be equal to 2, and the material limit quantity for the rating topic “water resource” may be equal to 1.

It is assumed that the material limit quantity is 2, the processing device 120 may filter out two target text materials from a plurality of text materials to be evaluated. It is assumed that the material limit quantity is 1, the processing device 120 may filter out one target text material from the plurality of text materials to be evaluated.

For example, taking table 4 as an example, it is assumed that the material limit quantity is 2, the processing device 120 may filter out two target text materials, which are respectively “air conditioning group control” and “air compressor maintenance adjustment” according to the recommended order of each text material to be evaluated.

In step S620, the processing device 120 uses the generative language model to generate report content related to the rating topic in the report according to at least one target text material in the plurality of text materials to be evaluated and a style parameter. In detail, the processing device 120 may perform fine-tune training on the pre-trained language model according to a plurality of historical CSR reports, so as to establish the generative language model. In more detail, the processing device 120 may extract sentences in the historical CSR reports to perform the fine-tune training on the pre-trained language model, so as to generate the generative language model suitable for writing the CSR report. The generative language model is, for example, a GPT model, but the disclosure is not limited thereto. The task of the generative language model includes generating the report content based on the target text material and a style parameter. Namely, the generative language model may generate a new text according to the given target text material and style parameter, and the processing device 120 may use the above new text as a part of the content of the report. The style parameter is used to determine a narrative style of the report content generated by the generative language model. In some embodiments, when used to generate a CSR report of the enterprise, the style parameter may include manufacturing original equipment manufacturer (OEM), parts supply, or other narrative styles.

In some embodiments, the processing device 120 may input the style parameter and the target text material into the generative language model through the question instruction, so that the generative language model may generate the corresponding report content. For example, the above question instruction may be “please generate the CSR report content related to the air conditioning group control and air compressor maintenance adjustment to reduce annual carbon emission by 10% in the manufacturing OEM style”, and the generative language model may generate the report content of “through energy-saving technical transformation of the factory area, the adjustment of air conditioner and air compressor, including air conditioning group control and air compressor maintenance adjustment, will reduce the annual carbon emission by 10% as a whole”, which is considered here that the style parameter is A content of the manufacturing OEM style. In an embodiment, the above-mentioned question instruction may be “please generate the CSR report content related to the air-conditioning group control and air compressor maintenance adjustment to reduce the annual carbon emission by 6% and 4% respectively in the parts supply style”, then the generative language model may generate the report content of “this year, there are equipment improvements in the factory area, including air-conditioning group control to reduce carbon emission by 6% and air compressor maintenance adjustment to reduce carbon emissions by 4%”, which is considered here that the style parameter is B content of the parts supply style. In an embodiment, the processing device 120 outputs a level comparison result (i.e., level classification) of “1” through the text level classification model based on the above-mentioned A content and B content, which represents that the rating of the A content is greater than or equal to the rating of the B content. Namely, the narrative style of the A content is superior to the narrative style of the B content.

From this example, it is learned that in the CSR report written in the manufacturing OEM style, the parts about air conditioning group control and air compressor maintenance may have better ratings.

In some embodiments, the processing device 120 may input the style parameter and the target text material into the generative language model through the question instruction, so that the generative language model may generate the corresponding report content. For example, the above-mentioned question instruction may be “please generate the CSR report content related to recycling of production wastewater and the annual wastewater reuse rate of air conditioner hot water circulation to increase by 20% in the manufacturing OEM style”, then the generative language model may, for example, generate the report content of “through the reuse of wastewater in the factory area, the adjustment of the reuse method of water resources includes the adjustment of production wastewater and air conditioning hot water circulation, increasing the annual wastewater reuse rate by 20% in overall”, which is considered here that the style parameter is A content of the manufacturing OEM style. In an embodiment, the above-mentioned question instruction may be “please generate the CSR report content related to the recycling and reuse of production wastewater, and the annual wastewater reuse rate of air conditioning hot water circulation to increase by 15% and 5% respectively in the parts supply style”, then the generative language model may, for example, generate the report content of “this year, the factory area has adjusted the wastewater utilization method, including increasing the recycling of production wastewater by 15% and increasing usage rate of air conditioning hot water circulation by 5%”, which is considered here that the style parameter is B content of the parts supply style. In an embodiment, the processing device 120 outputs a level comparison result (i.e., level classification) of “0” through the text level classification model based on the above-mentioned A content and B content, which represents that the rating of the A content is lower than the rating of the B content, i.e., the narrative style of the B content is superior to the narrative style of the A content.

From this example, it is learned that in the CSR report written in the parts supply style, the parts about waste water recycling, air conditioning hot water circulation may have better ratings.

In some embodiments, the processing device 120 may integrate the report content with a narrative style of a higher rating into the report content based on each target text material. For example, continuing the result of the above example, since the A content corresponds to a narrative style with a higher rating, the processing device 120 selects to integrate the A content into the report content. In addition, if the number of options for the narrative styles is more than two, any two narrative styles may be integrated into a style combination. In an embodiment, the processing device 120 inputs the two report contents respectively corresponding to the two narrative styles into the text level classification model to obtain a level comparison result (i.e., level classification result) between the two narrative styles. In another embodiment, the processing device 120 respectively inputs the two report contents respectively corresponding to two style combinations into the text level classification model to obtain a level classification result between the two style combinations. In this way, according to the level classification result of each style combination, the processing device 120 may obtain a style recommendation order of all narrative styles, and may select the report content with higher priority according to the style recommendation order to generate a final report.

In some embodiments, the processing device 120 may use the text level classification model to compare the report content of the current year with at least one historical report content, so as to obtain the predicted level information of the report content of the current year. In detail, the above description is an example in which the processing device 120 obtains the final report content for one rating topic (such as a “carbon emission” standard). Based on the same principle and operation, the processing device 120 may obtain the corresponding final report contents for the other 36 rating topics in the same manner. Finally, after all the report content of the current year is generated, the processing device 120 may use the text level classification model to evaluate the report content of the current year in advance. Specifically, when the processing device 120 compares the report content of the current year with the historical report content of a historical year, the processing device 120 may perform rating evaluation and comparison based on following two methods. First, the processing device 120 may respectively input the report content of the current year and the historical report content of the historical year into the text level classification model for the 37 rating topics, so as to obtain the predicted level information corresponding to each rating topic. Then, by aggregating the predicted level information (i.e., level classification results) of the 37 rating topics, the processing device 120 may calculate a proportion of the rating topics that the report content of the current year is superior to the historical report content of the historical year. For example: it is assumed that the level comparison results corresponding to 30 rating topics are 1, it represents that the rating of the report content of the current year has a probability of 30/37=0.81 to be higher than that of the historical report content. Second, the processing device 120 may integrate the report content of the 37 rating topics into one overall report content, and input the report content of the current year and the historical report content of the historical year into the text level classification model, and the processing device 120 may obtain the level classification result of the report content of the current year and the historical report content. For example: it is assumed that the level comparison result output by the text level classification model is 1 and the rating of the historical year is AA, it represents that the level of the report of current year is evaluated to be better than AA.

Through the above process, first, the text level classification model may be established through report content of multi enterprises to help more accurate measurement of ratings obtained by rating agency in evaluation of CSR degrees. Compared with the current manual method, the above process may further output level classification, and output content with higher rating according to the level classification. Second, regarding a current actual length limit, the content is actually explained in a clear and concise way to meet a setting of the limit, and based on past experiences, the recommended order is automatically suggested in different explanatory materials and styles. In this way, on the one hand, the system may suggest target text materials with higher expected ratings, and on the other hand, it may also produce reports with higher ratings than the historical rating, which mitigates the reduction of ratings due to human error in explanations, so as to improve the overall report output efficiency and achieve the content with higher final rating.

In some embodiments, the target text material may include execution plan information and an influence degree parameter. For example, the execution plan information is, for example, “air conditioning group control” shown in Table 3 and Table 4. The influence degree parameter corresponding to the execution plan information is, for example, “10% reduction in annual carbon emission”.

In addition, in some embodiments, the processing device 120 may input a first style parameter and the target text material into the generative language model, and the generative language model generates a corresponding first report content. The processing device 120 may input a second style parameter and the target text material into the generative language model, and the generative language model generates a corresponding second report content. Then, the processing device 120 may input the first report content and the second report content to the text level classification model M1 shown in FIG. 4B, and the text level classification model M1 outputs a level comparison result of the first report content and the second report content. Alternatively, the processing device 120 may sequentially input the first report content and the second report content into the text level classification model M1 shown in FIG. 4B, and the text level classification model M1 sequentially outputs a classification level of the first report content and a classification level of the second report content. Therefore, the processing device 120 may select the first report content or the second report content to generate a report according to the level comparison result of the first report content and the second report content. Alternatively, the processing device 120 may select the first report content or the second report content to generate the report according to the classification level of the first report content and the classification level of the second report content.

It should be noted that, in some embodiments, the GPU 121 may be used to run and train the generative language model mentioned above, and the CPU 122 may be used to run and train the classification model in the text level classification model.

According to the above description, it is learned that the report content is to demonstrate the performance of the results in the form of narration. For different selection criteria and rating purposes, the processing device 120 of the embodiment of the disclosure may perform evaluations according to different rating topics, so as to use different expression directions for different rating topics to increase the probability of obtaining a higher rating. The method for recommending report material and the report material recommending system of the embodiment of the disclosure may pair the report content and rating scores of many different enterprises over the years, and mark the conforming standards and question answering methods through the report content, so as to measure the relationship between scores and content, and quickly and efficiently establish a first draft of the report through a text level classification model and a generative language model used to generate the report content. On the other hand, integrity of the disclosure of the report may also affect the score. This part uses the establishment of the text level classification model to sort the multiple materials to be disclosed in the current year, and the materials with higher scores will be disclosed first to achieve a purpose of partial high-score disclosure, and if the original enterprise unit does not provide complete materials, keywords may also be added and written as future prospects or to-do items, so that all rating topics are written into the first draft of the report, thereby strengthening the integrity of the disclosure of the report.

It may be seen that, the method for recommending report material and the report material recommending system of the embodiment of the disclosure may quickly and efficiently create a relatively high-score first draft through the text level classification model. For enterprises that have never written a report, there is an urgent need to use the generative language model to establish a writing template for collaboration. On the other hand, for companies that have already written reports, it is necessary to establish the text level classification model for historical and current year reports and select important disclosures. Therefore, the method for recommending report material and the report material recommending system of the embodiment of the disclosure achieve the effect of improving the overall report output efficiency and report quality.

The processing procedures of the method for recommending report material executed by at least one processing device are not limited to the examples of the above-mentioned embodiments. For example, a part of the steps (processing) described above may be omitted, and each step may be performed in another order. In addition, any two or more of the above steps may be combined, and a part of the steps may be corrected or deleted. Alternatively, other steps may also be performed in addition to the above steps.

In summary, in the embodiment of the disclosure, the text level classification model may be established according to a plurality of evaluated reports, so as to measure the recommended order of the text materials to be evaluated through the text level classification model. In this way, the target text materials for generating the report may be filtered out from the text materials to be evaluated. Therefore, compared to writing a report purely based on manual experience, the embodiment of the disclosure may generate report content with a higher rating based on the application of the text level classification model. In addition, through the application of the generative language model, errors in human writing may be reduced, and writing efficiency may also be improved. Therefore, the overall report output efficiency and report quality may be improved.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A method for recommending report material, adapted to a report material recommending system comprising a processing device, the method for recommending report material comprising:
obtaining a plurality of evaluated reports and an actual rating level of each of the evaluated reports;
extracting a plurality of reference text materials related to a rating topic from the evaluated reports;
performing a classification model training based on the reference text materials and the actual rating levels of the evaluated reports to establish a text level classification model;
determining predicted level information for each of text materials to be evaluated by using the text level classification model, to obtain a recommended order for each of the text materials to be evaluated; and
generating a report based on the recommended order of each of the text materials to be evaluated.

2. The method for recommending report material as claimed in claim 1, wherein the step of extracting the plurality of reference text materials related to the rating topic from the evaluated reports comprises:
performing fine-tune training on a pre-trained language model to establish a generative language model;
receiving a question instruction related to the rating topic; and
generating the plurality of reference text materials of the plurality of evaluated reports according to the question instruction through the generative language model.

3. The method for recommending report material as claimed in claim 2, wherein the processing device comprises a central processing unit and a graphics processing unit, and the method comprises:
running the generative language model through the graphics processing unit; and
running a classification model in the text level classification model through the central processing unit.

4. The method for recommending report material as claimed in claim 1, wherein the text level classification model comprises a feature extraction model and a classification model; wherein the plurality of evaluated reports comprise a plurality of corporate social responsibility reports.

5. The method for recommending report material as claimed in claim 4, wherein the step of performing the classification model training based on the reference text materials and the actual rating levels of the evaluated reports to establish the text level classification model comprises:
converting each of the plurality of reference text materials into a feature vector by using the feature extraction model;
inputting the feature vectors of each of the plurality of reference text materials into the classification model to generate a model prediction result; and
adjusting a model parameter of the feature extraction model and a model parameter of the classification model according to the actual rating levels of each of the plurality of evaluated reports and the corresponding model prediction result.

6. The method for recommending report material as claimed in claim 4, wherein the step of determining the predicted level information for each of the text materials to be evaluated by using the text level classification model, to obtain the recommended order for each of the text materials to be evaluated comprises:
converting each of the plurality of text materials to be evaluated into a feature vector by using the feature extraction model;
inputting the feature vectors of each of the plurality of text materials to be evaluated into the classification model to generate a classification level of each of the plurality of text materials to be evaluated; and
obtaining a recommended order of each of the plurality of text materials to be evaluated by sorting the classification levels of each of the plurality of text materials to be evaluated.

7. The method for recommending report material as claimed in claim 1, wherein the step of determining the predicted level information for each of the text materials to be evaluated by using the text level classification model, to obtain the recommended order for each of the text materials to be evaluated comprises:
using a feature extraction model to convert each of the plurality of text materials to be evaluated into a feature vector, wherein the text materials to be evaluated comprise a first text material to be evaluated and a second text material to be evaluated;
inputting the feature vector of the first text material to be evaluated and the feature vector of the second text material to be evaluated into a classification model to generate a level comparison result between the first text material to be evaluated and the second text material to be evaluated; and
obtaining the recommended order of each of the plurality of text materials to be evaluated according to the level comparison result of the first text material to be evaluated and the second text material to be evaluated.

8. The method for recommending report material as claimed in claim 1, wherein before the step of determining the predicted level information for each of the text materials to be evaluated by using the text level classification model, to obtain the recommended order for each of the text materials to be evaluated, the method further comprises:
replacing an influence value in each of the plurality of text materials to be evaluated with a preset value.

9. The method for recommending report material as claimed in claim 1, wherein the step of generating the report based on the recommended order of each of the text materials to be evaluated comprises:
filtering out at least one target text material from the plurality of text materials to be evaluated according to a material limit quantity and the recommended order of each of the plurality of text materials to be evaluated.

10. The method for recommending report material as claimed in claim 9, wherein the step of generating the report based on the recommended order of each of the text materials to be evaluated comprises:
using a generative language model to generate report content about the rating topic in the report according to the at least one target text material in the plurality of text materials to be evaluated and a style parameter.

11. A report material recommending system, comprising:
a storage device, storing a plurality of instructions;
a processing device, coupled to the storage device, and accessing the instructions to execute:
obtaining a plurality of evaluated reports and an actual rating level of each of the evaluated reports;
extracting a plurality of reference text materials related to a rating topic from the evaluated reports;
performing classification model training based on the reference text materials and the actual rating levels of the evaluated reports to establish a text level classification model;
determining predicted level information for each of text materials to be evaluated by using the text level classification model, so as to obtain a recommended order for each of the text materials to be evaluated; and
generating a report based on the recommended order of each of the text materials to be evaluated.

12. The report material recommending system as claimed in claim 11, wherein the processing device further executes:
performing fine-tune training on a pre-trained language model to establish a generative language model;
receiving a question instruction related to the rating topic; and
generating the plurality of reference text materials of the plurality of evaluated reports according to the question instruction through the generative language model.

13. The report material recommending system as claimed in claim 12, wherein the processing device comprises a central processing unit and a graphics processing unit, the graphics processing unit runs the generative language model, and the central processing unit runs a classification model in the text level classification model.

14. The report material recommending system as claimed in claim 11, wherein the text level classification model comprises a feature extraction model and a classification model, the plurality of evaluated reports comprise a plurality of corporate social responsibility reports.

15. The report material recommending system as claimed in claim 14, wherein the processing device further executes:
converting each of the plurality of reference text materials into a feature vector by using the feature extraction model;
inputting the feature vectors of each of the plurality of reference text materials into the classification model to generate a model prediction result; and
adjusting a model parameter of the feature extraction model and a model parameter of the classification model according to the actual rating levels of each of the plurality of evaluated reports and the corresponding model prediction result.

16. The report material recommending system as claimed in claim 14, wherein the processing device further executes:
converting each of the plurality of text materials to be evaluated into a feature vector by using the feature extraction model;
inputting the feature vectors of each of the plurality of text materials to be evaluated into the classification model to generate a classification level of each of the plurality of text materials to be evaluated; and
obtaining a recommended order of each of the plurality of text materials to be evaluated by sorting the classification levels of each of the plurality of text materials to be evaluated.

17. The report material recommending system as claimed in claim 11, wherein the processing device further executes:
using a feature extraction model to convert each of the plurality of text materials to be evaluated into a feature vector, wherein the text materials to be evaluated comprise a first text material to be evaluated and a second text material to be evaluated;
inputting the feature vector of the first text material to be evaluated and the feature vector of the second text material to be evaluated into a classification model to generate a level comparison result between the first text material to be evaluated and the second text material to be evaluated; and
obtaining the recommended order of each of the plurality of text materials to be evaluated according to the level comparison result of the first text material to be evaluated and the second text material to be evaluated.

18. The report material recommending system as claimed in claim 11, wherein the processing device further executes:
replacing an influence value in each of the plurality of text materials to be evaluated with a preset value.

19. The report material recommending system as claimed in claim 11, wherein the processing device further executes:
filtering out at least one target text material from the plurality of text materials to be evaluated according to a material limit quantity and the recommended order of each of the plurality of text materials to be evaluated.

20. The report material recommending system as claimed in claim 19, wherein the processing device further executes:
using the generative language model to generate report content about the rating topic in the report according to the at least one target text material in the plurality of text materials to be evaluated and a style parameter.
